(19) United States
(12) Patent Application Publication
(10) Pub. No.: US 2006/0294256 A1
(43) Pub. Date: Dec. 28, 2006

(54) Method for automating standard operation procedure

(75) Inventor: Tsung-Chun Chen, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/182,805

(22) Filed: Jul. 18, 2005

Related U.S. Application Data
(63) Continuation-in-part of application No. 11/165,134, filed on Jun. 24, 2005.

(51) Int. Cl. G06F 15/173

(52) U.S. Cl. 709/240

(57) ABSTRACT

The present invention discloses a method for automating a standard operation procedure, comprising: editing multiple operation data, which describe the execution procedures of operations in detailed, into a standard operation procedure; recording the operation data respectively in multiple electronic operation procedure files; sequentially transferring the contents of those multiple operation procedure files to at least one workstation according to the execution sequence via a communication network; and presenting the contents of the operation procedure files on the workstations in order to guide or direct operators to execute the contents of the operation procedure files. The method for automating a standard operation procedure of the present invention can realize electronic and information-based data transference of a standard operation procedure and can improve the problems of the conventional method that paper documents of operation procedure data are issued by man.

This application is a continuation-in-part, and claims priority, of from U.S. patent application Ser. No. 11/165,134 filed on Jun. 24, 2005, entitled “Support system for standard operation procedure”.

### FIELD OF THE INVENTION

The present invention relates to a method for automatically distributing and transferring operation data, particularly to a method for automating a standard operation procedure, which realizes electronic and information-based data of a standard operation procedure and realizes the electronic and information-based distribution and transference thereof.

### BACKGROUND OF THE INVENTION

In general, a Standard Operation Procedure (SOP) is defined as “a written document describing the execution process of a routine or repeated task in detail, such as various inspections and operations, in order to standardize and uniformize the procedure of the task”. In other words, the basic concept of SOP is to standardize and uinformize the information relating to the operation procedure of a task.

For a fabrication operation, the primary objective of pushing SOP is to lower the defective fraction resulting from human errors, to reduce cost, and to achieve quality uniformity. Exemplified with a production line, the operators at all the stages of a production line respectively undertake different operations in order to cooperate to finish the assembling or manufacturing task of some product according to a scheduled operation procedure; for example, the assembling of some product is completed together by the operators of multiple successive workstations, and the operation contents executed in each workstation is according to operation data recording the information of the operation procedure. Traditionally, SOP is recorded in a dead-tree-ware and is issued to every workstation by man, and SOP's of different products are distinguished with part numbers or other identification numbers.

Such a traditional SOP execution method has some disadvantages:
1. planning and making those paper documents expends more time;
2. renewing or updating the contents of those paper documents is slow and inconvenient; the task of a product line tends to be diversified nowadays, and it is hard for a paper document SOP to update or renew its contents when the task is changed or modified;
3. storing and managing those paper documents is not easy.

The U.S. Patent publication No. 20010034756 discloses a laboratory information system, which is of an SOP-oriented architecture. This laboratory information system can help scientists manage experiment-related routine works and documents. However, this conventional technology does not disclose any technology about supporting or directing multiple operators, such as those in a production line, to cooperate to complete a task.

Besides, the U.S. Patent publication No. 20020075604 A1 discloses a group work control system and method to support a cooperative technical development task of a product, wherein multiple workers separately undertake multiple development procedures. Via this system and method, development task-related information can be rapidly transmitted to every technical developer, and the technical developers can also acquire application software they need, information of development schedule, etc. In other words, the primary function of this system and method is to support a cooperative technical development, wherein multiple workers undertake a special technology development project according to a given schedule, such as a semiconductor technology development project. However, the method with respect to supporting multiple workers to cooperate to complete a task in a production line is not disclosed in this patent.

### SUMMARY OF THE INVENTION

The present invention discloses a method for automating a standard operation procedure, which can automate the SOP information distribution and transference and can replace the traditional paper-based SOP execution process.

According to one embodiment of the present invention, the method for automating a standard operation procedure of the present invention comprises: editing multiple operation data, which describe the execution procedures of operations in detailed, into a standard operation procedure; recording the operation data respectively in multiple electronic files of operation procedures; sequentially transmitting the contents of multiple operation procedure files to at least one workstation according to the execution sequence via a communication network; and presenting the contents of the operation procedure files on the workstations in order to guide or direct operators to execute the operations.

The present invention also discloses a method for automating standard operation procedure update, which can automatically update the contents of SOP information and can provide timely and correct SOP information.

According to another embodiment of the present invention, the newest operation information can be automatically acquired at a preset time via an automatic-update processing logic, or when there is a shift or update in operation information.

The present invention is to be further clarified below with preferred embodiments

### BRIEF DESCRIPTION OF THE DRAWINGS

FIG. 1 is a preferred embodiment of the method according to the present invention.

FIG. 2 is a preferred embodiment of the data architecture of the task database according to the present invention.

FIG. 3 is a diagram showing the system architecture of another preferred embodiment according to the present invention.

FIG. 4 is a diagram showing the system architecture of yet another preferred embodiment according to the present invention.

FIG. 5 is a preferred embodiment of the method of the automatic SOP update according to the present invention.

FIG. 6 is another preferred embodiment of the method of the automatic SOP update according to the present invention.

FIG. 7 is a diagram showing the system architecture of further another preferred embodiment according to the present invention.

### DETAILED DESCRIPTION OF THE PREFERRED EMBODIMENTS

In principle, the present invention is a method to realize electronic and information-based SOP data, which describe the execution process of multiple operation procedures in detail, and to realize an electronic and information-based distribution and transference of those operation data to workstations, in order to improve the problems of the conventional method that paper documents of operation procedure data are issued by man.

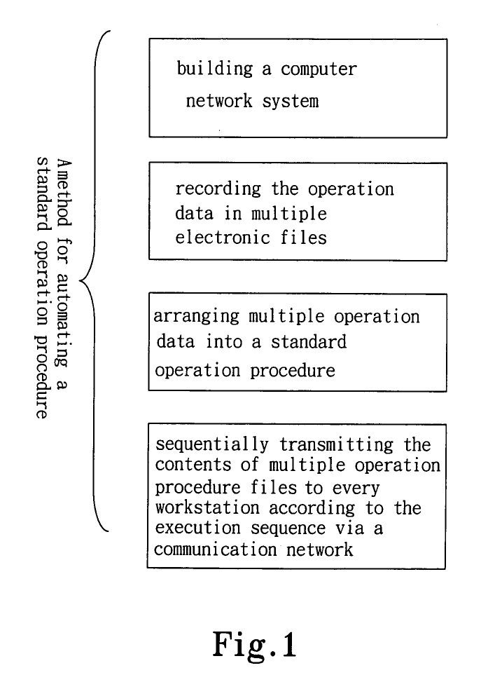

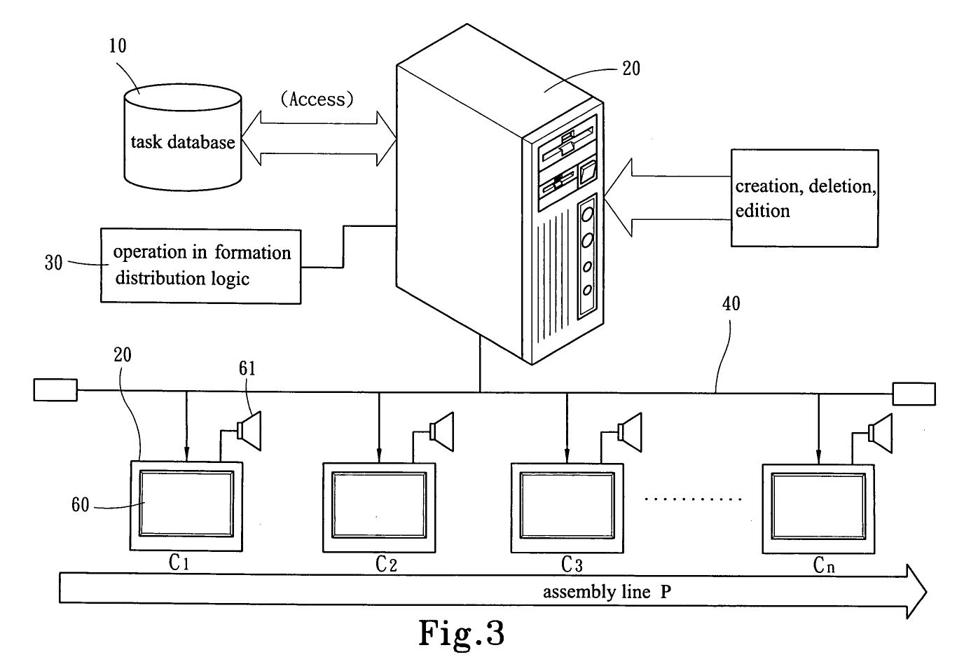

Refer to FIG. 1. According to one embodiment of the present invention, the method for automating a standard operation procedure of the present invention comprises:
(1) building a computer network system with workstations C1˜Cn being network terminals, which further comprises: building a task database 10, installing display interfaces 60 on the network terminals, and installing an operation information distribution logic 30 (referring to FIG. 3);
(2) recording multiple operation data, which describe the execution process of multiple operation procedures in detail, respectively in multiple electronic operation procedure files;
(3) arranging multiple operation procedure files into a standard operation procedure according to operation execution sequence; and
(4) sequentially distributing and transferring operation procedure files to at least one display interface 60 on the workstations C1˜Cn according to the operation execution sequence.

This embodiment is to be further exemplified by a production line. In general, a production line comprises at least one workstation, and according to fabrication procedure, those workstations C1˜Cn are arranged into a complete production line P. Respectively according to different operation data, operators in those workstations C1˜Cn cooperate to finish the assembling or the processing of a product (a finished product or a semi-finished product). In other words, via the operation information distribution logic 30, the operation data are distributed to those beforehand-arranged workstations C1˜Cn to direct the operators to execute the contents of the operation data. It is obvious that any one of the workstations C1˜Cn may also be a group or groups for executing contents of some operation data according to the arrangement of SOP.

The display interface 60 in the abovementioned step (1) can be either a CRT (cathode ray tube) display device or an LCD (liquid crystal display) display device. The preferred embodiment thereof may further comprise installing audio output devices 61 on those workstations C1˜Cn (referring to FIG. 3), and the audio output device 61 may be but is not limited to a speaker or its equals. The audio output device 61 can output voice to direct the operators to finish the contents of the operation procedure files.

In the abovementioned step (2), multiple operation data, which describe the execution process of multiple operation procedures in detail, is arranged according to the operation execution sequence and recorded as a standard operation procedure in order to direct the operators in those workstations C1˜Cn to execute assigned operation. The “operation data” may be but is not limited to texts, pictures, drawings, video data, audio signal, multimedia information, or any combination of them. The “operation data” is to provide operation guides and references for any operator of those workstations C1˜Cn in order to direct the operators to execute the operations of their own workstations so that the operators of all the workstations can cooperate to complete some task, such as assembling operations or other tasks.

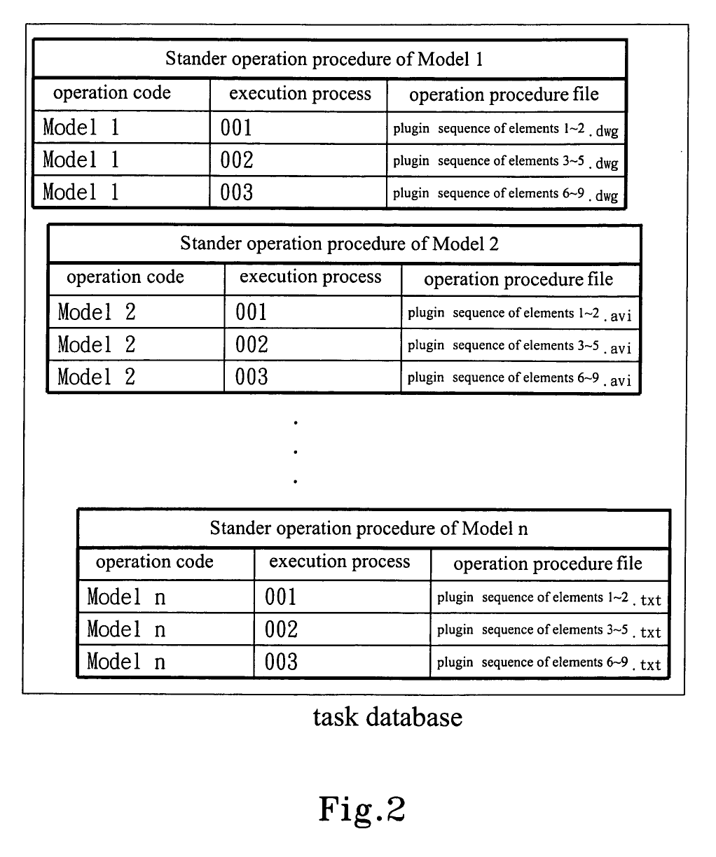

In the abovementioned step (3), the operation procedure files, which describe the execution process of this operation in detail, are stored in the task database 10 by each individual operation, and a code is used to designate those operation procedure files belonging to an identical operation. The data structure thereof can be as that shown in FIG. 2. For example, in product fabrication operations, the SOP's of different products are designated by operation codes, and the operation code may be a part number, a model number, or other identification numbers.

The operation information distribution logic 30 will retrieve right operation procedure files from the task database 10 according to the operation code. What is retrieved may be an operation procedure file or more than one operation procedure file. Sequence numbers, which denote the execution sequence of those operation procedure files, may be given to those operation procedure files. Via the communication network 40, the operation information distribution logic 30 can also transfer those operation procedure files respectively to at least one of the workstations C1˜Cn according to the sequence numbers.

In principle, each of the workstations C1˜Cn has its own address identification code in this computer network. It is preferred to use an address-mapping table to correlate those operation procedure files with the address identification codes of the workstations C1˜Cn. Thereby, the operation procedure file can be distributed and transferred to the display interface 60 of the workstation of a specified address via the communication network 40 in order to present the contents of the operation procedure file. An available example thereof is to be described below. The address identification codes can be given to the abovementioned display interfaces 60. The communication network 40 may be an intranet of the enterprise, a LAN (local area network) or the Internet, which meets the wire network standard 802.3 or the wireless network standard 802.11. The communication network 40 can be coupled to the display interfaces 60 of the workstations C1˜Cn via a hardware communication port, which may be but not limited to RS-232 or RJ-45. The address identification codes of the workstations C1˜Cn can be implemented with TCP/IP protocol, a multi-panel display card or a hardware locator, which the persons skilled in the art can easily realize according to the present invention.

According to one embodiment of the present invention, the architecture of the computer network system in the present invention may be a client/server one (referring to FIG. 3). The task database 10 is stored inside a built-in computer-accessible recording medium of the operation procedure distribution server 20, and the recording medium may be but is not limited to a hard disk, an optical disk, or other equals. The operation information distribution logic 30 can be implemented with a software or a firmware installed inside the operation procedure distribution server 20.

The task database 10 supports the operation information distribution logic 30 and provides the operation procedure files for the operation information distribution logic 30. Via the operation procedure distribution server 20, the maintenance personnel can undertake creation, deletion, or edition, etc. on the operation procedure files of any SOP, and can arrange the tasks and related operation procedure data, which are to be assigned to the production line P or the workstations C1˜Cn.

In the embodiment shown in FIG. 3, the task database 10 and the operation procedure distribution server 20 communicate via the communication network 40. The operation information distribution logic 30 obtains to-be-issued operation procedure files from the task database 10 and transfers the obtained operation procedure files to the workstations C1˜Cn via the communication network 40. The task assignment can be performed via the operation interfaces provided by the operation procedure distribution server 20 or the workstations C1˜Cn. Via the operation procedure distribution server 20, the maintenance personnel can undertake a modification or update action, such as creation, deletion, or edition, etc., on any SOP.

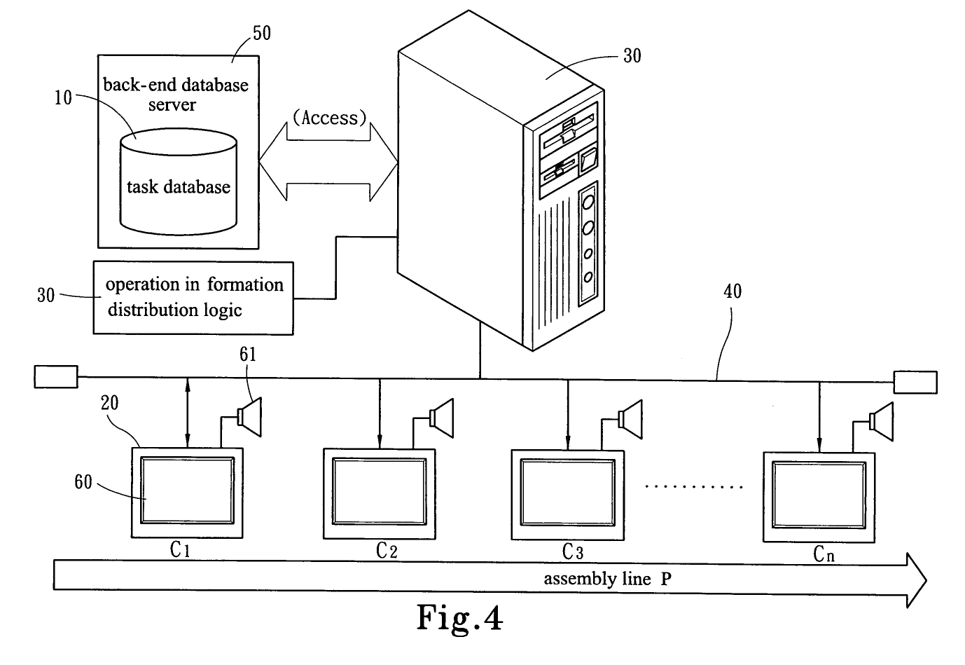

According to another embodiment of the present invention, the architecture of the computer network system in the present invention may also be an N-Tier one. The task database 10 is stored inside a built-in computer-accessible recording medium of a back-end database server 50, as shown in FIG. 4, and the operation procedure distribution server 20 is interposed between the workstations C1˜Cn and the back-end database server 50. The operation procedure distribution server 20 obtains corresponding operation procedure files from the task database 10 inside the back-end database server 50 according to the assigned task, and then distributes and transfers the obtained operation procedure files to the workstations C1˜Cn via a communication network 40. Such a 3-tier architecture can support more operation procedure distribution servers 20, and thereby, SOP can be executed in more production lines P. The SOP maintenance personnel can utilize the operation interface of the operation procedure distribution server 20 or the back-end database server 50 to undertake modification or update action, such as creation, deletion, or edition, etc., on any operation procedure file.

The present invention also comprises one embodiment of automatic SOP update, which is performed via an automatic-update processing logic, in order to provide timely and correct SOP information. The automatic-update processing logic can also be implemented with a software or a firmware. The available implementation methods include the following two methods:

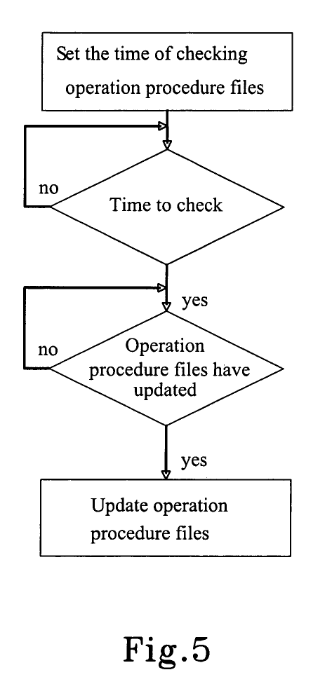

As shown in FIG. 5, one of those available implementation methods of automatic SOP update is: the operation procedure files are to be automatically checked at preset time, such as when the production line stops operating; once any change in the operation procedure files or a new edition of the operation procedure files is found, the automatic-update processing logic will obtain the updated operation procedure files; the automatic-update processing logic can be initiated in the client end or the server end; for example, in the client/server architecture, it can be undertaken by the automatic-update processing logic installed beforehand in the display interface 60, or be executed by the operation procedure distribution server 20.

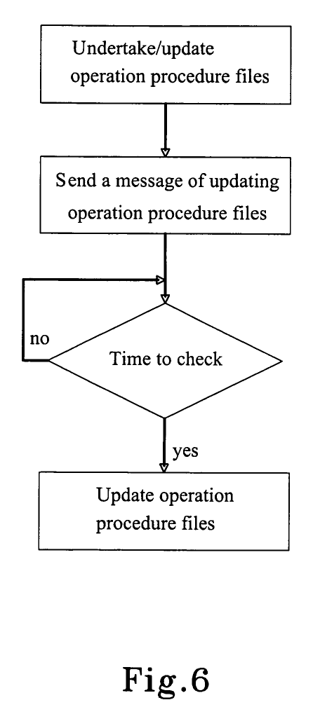

As shown in FIG. 6, the other one of those available implementation methods of automatic SOP update is: when the SOP maintenance personnel undertakes a modification or update action, such as creation, deletion, or edition, etc., on any SOP, a message is sent to the operation information distribution logic 30 to demand the operation information distribution logic 30 to update the operation procedure files at a preset time or when the production line P stops operating.

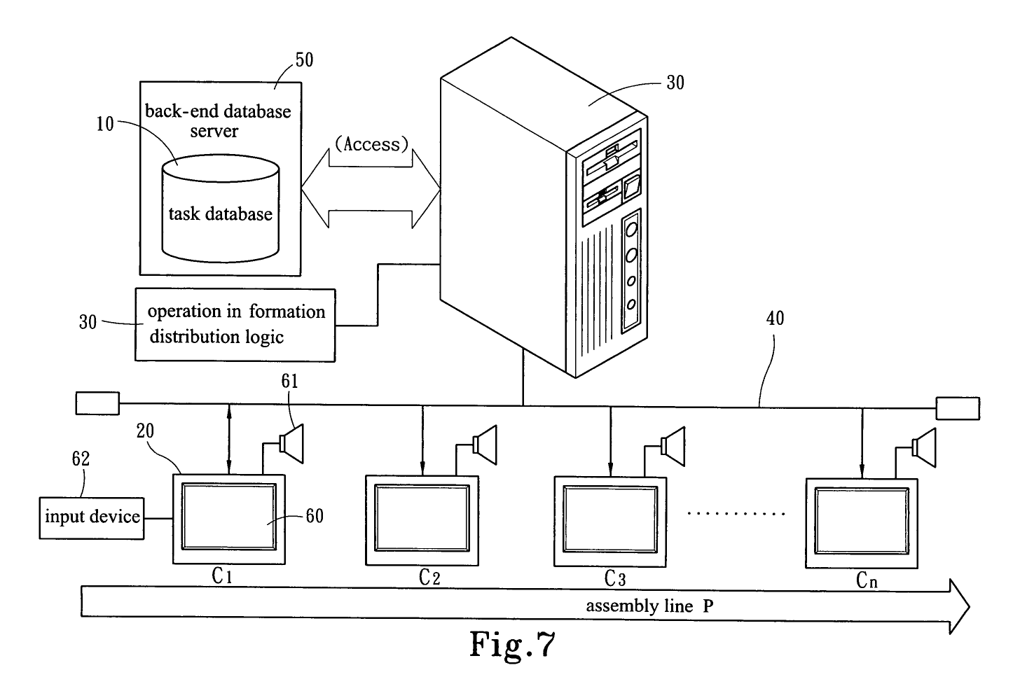

As shown in FIG. 7, according to a preferred embodiment of the present invention, the workstations C1˜Cn further comprise input devices 62, via which the operators can input operation instructions to operate the “operation procedure data” presented by the information display interface 60. Herein, the aforementioned “operating the operation procedure data” may includes but is not limited to the operation of page-up/down (an operation procedure file may comprises multiple information pages), zoom-out, zoom-in, sequential play, repeated play, or pause. Besides, when the operators are authorized, they can select or change the SOP of the production line via this input device 62. For example, when the product of a production line P is changed, it can change the SOP of the production line P. The input device 62 may be buttons, a touch panel, a cursor controller, or any combination of them. Another preferred embodiment thereof further comprises a graphic user interface (GUI), which can provide the operators with visualized operation environments and promote operation convenience. Further, cooperating with a wireless communication network 40, the display interface 60 and/or the input device 62 of the workstation may also be a portable device, which includes but is not limited to a notebook computer, a table computer or a personal digital assistant. Owing to the movability of the potable device, the workstations C1˜Cn will have superior convenience, flexibility, and expandability in changing the configuration thereof.

The preferred embodiments disclosed above are only to disclose the present invention but not intended to limit the scope of the present invention. Any modification and variation made by the person skilled in the art according to the spirit of the present invention is to be included within the scope of the present invention.

What is claimed is:

1. A method for automating a standard operation procedure, comprising:
(1) building a computer network system with workstations being network terminals, which further comprises: building a task database, installing display interfaces on the network terminals, and installing an operation information distribution logic;
(2) recording multiple operation data, which describe an execution process of multiple operation procedures in detail, respectively in multiple electronic operation procedure files;
(3) arranging the multiple operation procedure files, which are needed in the execution process, into a standard operation procedure according to operation execution sequence; and
(4) sequentially distributing and transferring the operation procedure files to at least one display interface on the workstations according to the operation execution sequence.

2. The method for automating a standard operation procedure according to claim 1, further comprising a step of giving each of the display interfaces on the workstations an address identification code.

3. The method for automating a standard operation procedure according to claim 2, wherein the address identification code can be implemented with one of the group of TCP/IP protocol, a multi-panel display card and a hardware locator.

4. The method for automating a standard operation procedure according to claim 1, wherein the display interfaces can be selected from a CRT (cathode ray tube) display device and an LCD (liquid crystal display) display device.

5. The method for automating a standard operation procedure according to claim 1, wherein the format of the operation procedure file can be selected from a text, a picture, a drawing, video data, audio signal, multimedia information, and any combination of them.

6. The method for automating a standard operation procedure according to claim 1, wherein the operation procedure files, which describe the execution process of the operation in detail, are stored in the task database and a code is used to designate the multiple operation procedure files belonging to an identical operation.

7. The method for automating a standard operation procedure according to claim 1, wherein the computer network system is a client/server architecture; the task database is stored inside a built-in computer-accessible recording medium of an operation procedure distribution server; and the operation information distribution logic can be implemented with one of a software and a firmware installed inside the operation procedure distribution server.

8. The method for automating a standard operation procedure according to claim 7, further comprising a step of selecting the standard operation procedures via selecting from the workstations and the operation procedure distribution server.

9. The method for automating a standard operation procedure according to claim 8, wherein the workstations select the standard operation procedures from the task database via a graphic user interface.

10. The method for automating a standard operation procedure according to claim 1, wherein the architecture of the computer network system is a 3-Tier and comprises: a back-end database server, used to store the task database; and an operation procedure distribution server, interposing between the workstations and the back-end database server, and communicating with the workstations and the back-end database server via the network.

11. The method for automating a standard operation procedure according to claim 1, wherein the workstation further comprises an input device, via which the operator can input an operation instruction.

12. The method for automating a standard operation procedure according to claim 11, wherein the input device may be selected from buttons, a touch panel, a cursor controller, and any combination of them.

13. The method for automating a standard operation procedure according to claim 1, wherein the network is a wireless communication network.

14. The method for automating a standard operation procedure according to claim 1, wherein the network is a wire communication network.

15. The method for automating a standard operation procedure according to claim 1, wherein the display interface of the workstations is a portable device.

16. The method for automating a standard operation procedure according to claim 15, wherein the portable device may be selected from a notebook computer, a table computer and a personal digital assistant.

17. The method for automating a standard operation procedure according to claim 15, wherein the portable device has a liquid crystal display device and an input device.

18. The method for automating a standard operation procedure according to claim 17, wherein the input device may be selected from buttons, a touch panel, a cursor controller, and any combination of them.
